(19) United States
(12) Patent Application Publication
(10) Pub. No.: US 2012/0299741 A1
(43) Pub. Date: Nov. 29, 2012

(54) MATTRESS SHOWROOM DISPLAY DEVICE

(75) Inventor: William D. Wright, JR., Chattanooga, TN (US)

(73) Assignee: WRIGHT OF THOMASVILLE, INC., Thomasville, NC (US)

(21) Appl. No.: 13/115,263

(22) Filed: May 25, 2011

(51) Int. Cl. G09F 9/33

(52) U.S. Cl. 340/815.45

(57) ABSTRACT

A mattress showroom display device for a mattress, headboard or pillow presents selectively changeable product information regarding the mattress. The display device comprises a separate panel of such size and shape as to cover at least a portion of a surface of the mattress, headboard, or pillow. The display device includes a media display in the form of an area of programmable light emitting units associated with the separate panel for presenting the selectively changeable visual product information regarding the mattress. The media display has the capability to electronically connect to a power source and the programmable product information control source.

### FIELD OF THE INVENTION

The present invention relates to a media display device for presenting selectively changeable product information in a mattress showroom environment.

### BACKGROUND OF THE INVENTION

Mattresses are displayed in showrooms during the sale and distribution from the mattress manufacturer to the consumer. First of all, mattress manufacturers may display mattresses in wholesale showrooms so that retailers can get an idea of how the mattress will look in their own retail showrooms. In retail showrooms, display mattresses are arranged on the retail floor so that the prospective purchaser can peruse the various types of mattresses offered by that retailer. In each situation, marketing and/or technical features of the mattresses are communicated to the prospective purchaser via signage, labels or a personal communication between the sales representative and the prospective purchaser.

### SUMMARY OF THE INVENTION

The inventor has developed a way to display product information regarding a mattress to a prospective purchaser in a mattress showroom. A mattress showroom display device for a mattress, headboard or pillow presents selectively changeable product information regarding the mattress. The display device comprises a flexible panel of such size and shape as to cover at least a portion of a surface of the mattress, headboard, or pillow. The display device includes a media display in the form of an area of programmable light emitting units associated with the flexible panel for presenting the selectively changeable visual product information. The media display is capable of having an electronic connection with a power source and the programmable product information control source.

The term “foot portion,” as used herein, means the lower inches (10-30 inches) of the upper surface of the mattress where a customer's feet would rest if the customer were to fully lie on the mattress to test the comfort and support. The term “foot protector,” as used herein, means a device used to cover at least a part of the foot portion of a mattress. The term “product information” as used herein refers to any video content, presentations, images, or any other audio, video or audio/visual content for displaying advertising materials, sales materials, manufacturer's logos and trademarks, or promotional materials arranged and/or developed for display on a media device.

### BRIEF DESCRIPTION OF THE DRAWINGS

FIG. 1A is a perspective view of a display device on mattress foot protector attached to a mattress.

FIG. 1B is a perspective view of a mattress display device on the foot portion of a mattress.

FIG. 1C is a perspective view of a mattress display device on a headboard of a mattress.

FIG. 1D is a perspective view of a mattress display device on pillows.

FIG. 2 is a schematic representation plan view of a mattress display device according to the present invention.

FIGS. 3A and 3B are plan views and top perspective views, respectively, of a mattress display device on a mattress foot protector with the control source and power source, illustrated schematically.

### DETAILED DESCRIPTION

Certain exemplary embodiments of the present invention are described below and illustrated in the accompanying figures. The embodiments described are only for purposes of illustrating the present invention and should not be interpreted as limiting the scope of the invention, which, of course, is limited only by the claims below. Other embodiments of the invention, and certain modifications and improvements of the described embodiments, will occur to those skilled in the art and all such alternate embodiments, modifications, and improvements are within the scope of the present invention.

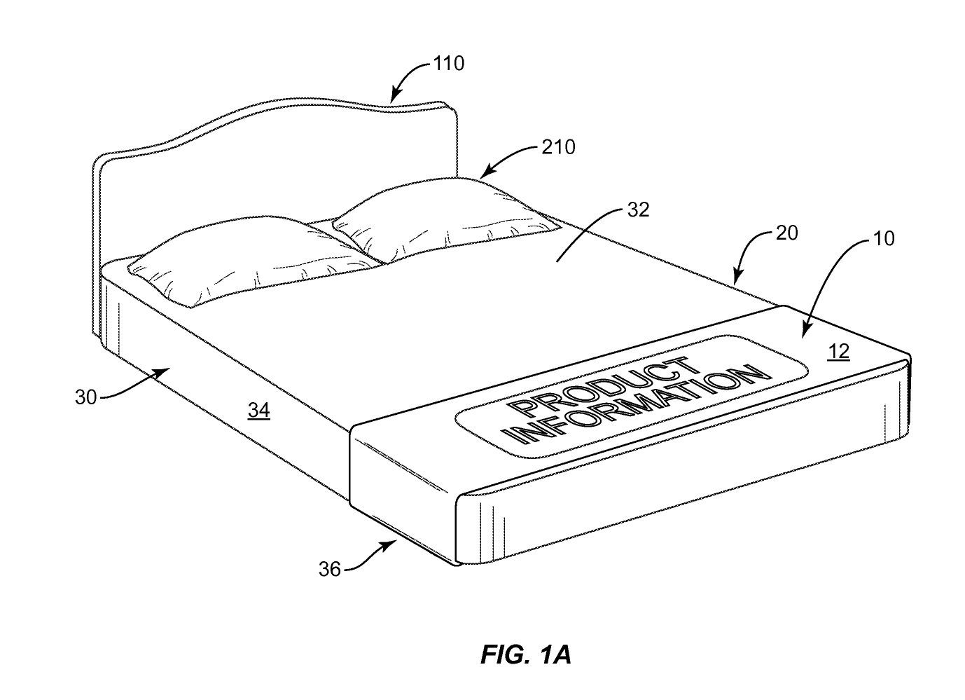

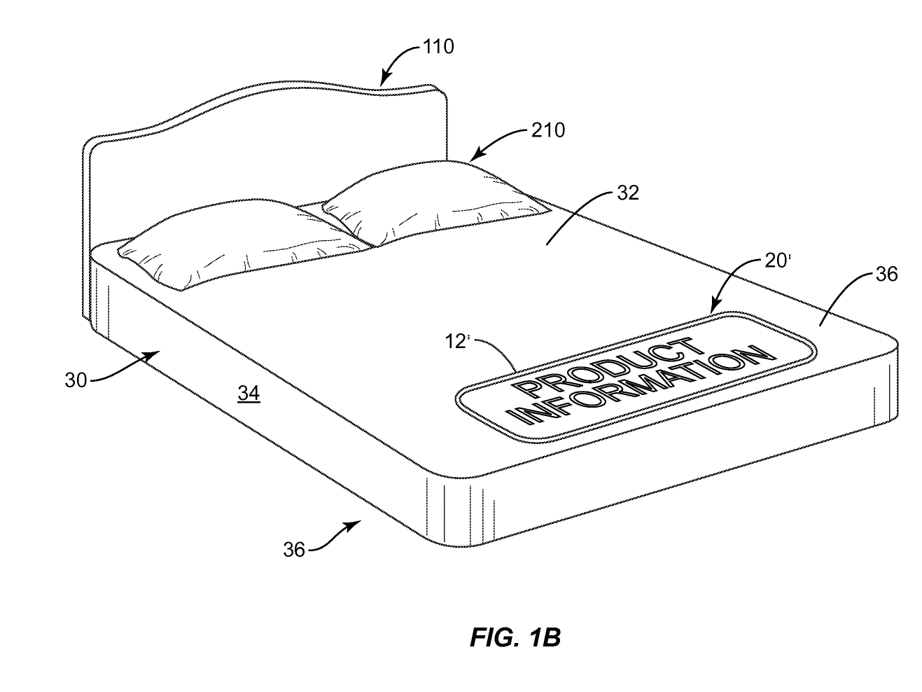

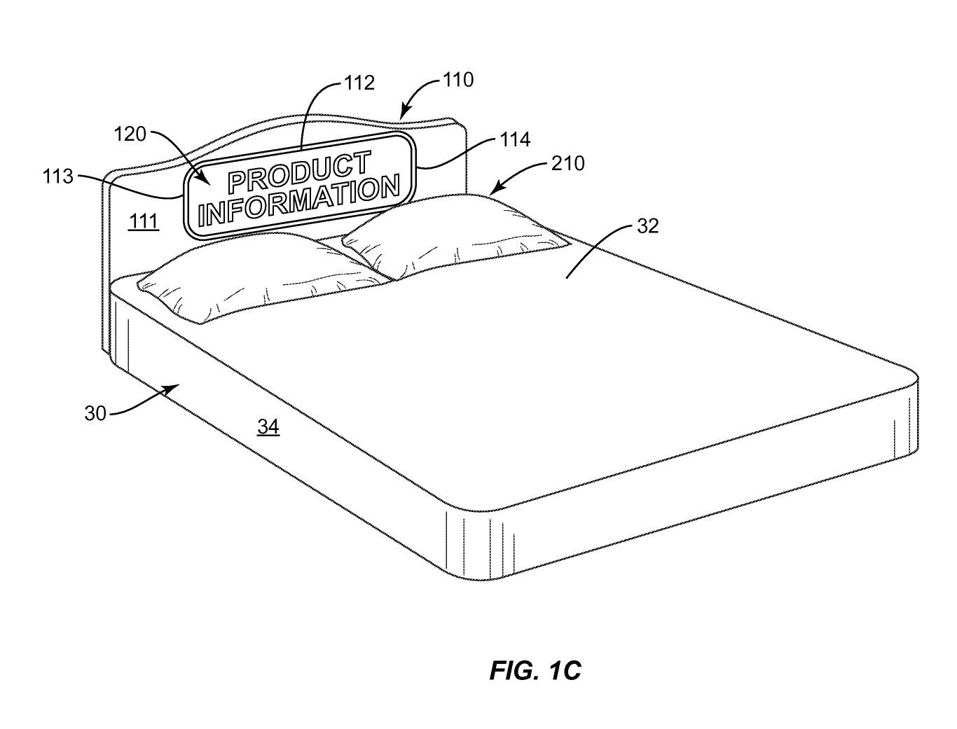

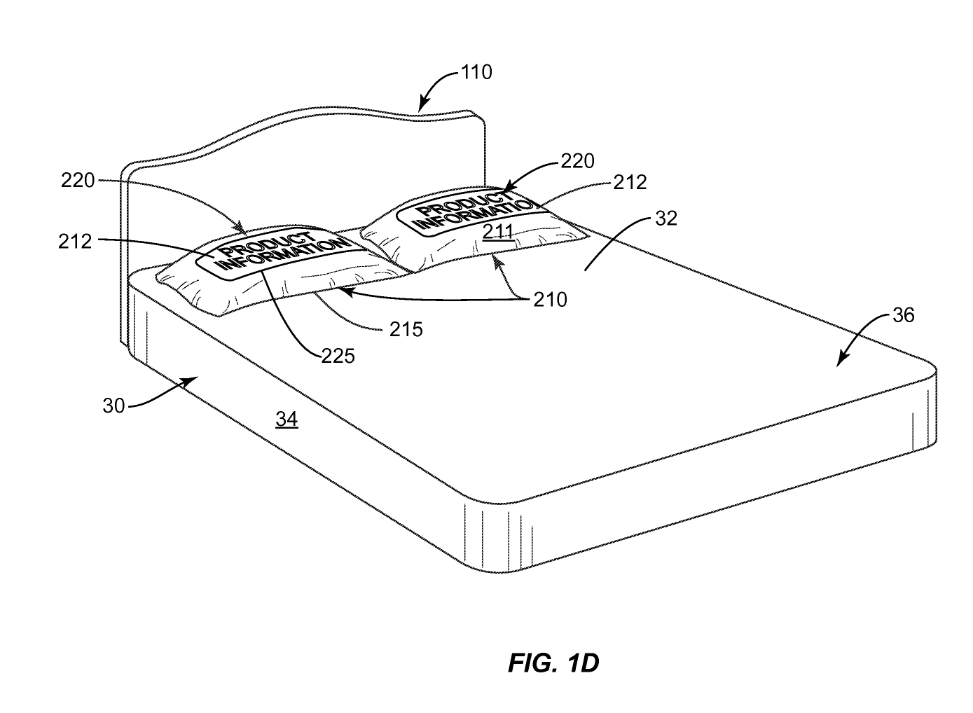

FIGS. 1A through 1D show a display device 20 which may either be associated with a mattress foot protector 10, headboard 110, and pillows 210, respectively, or a combination of them for use in a mattress showroom environment. The phrases “mattress showroom display device” and “media display device” are used interchangeably herein. As shown in the Figures, the media display device 20 is associated with the foot protector 10, headboard 110, and pillows 210 in some manner, such as being embedded therein, or incorporated into a separate panel 12 affixed to or laid upon the various mattress components. The flexible panel 12 has a size and shape to cover at least a portion of the surface of the foot protector, headboard and/or pillow.

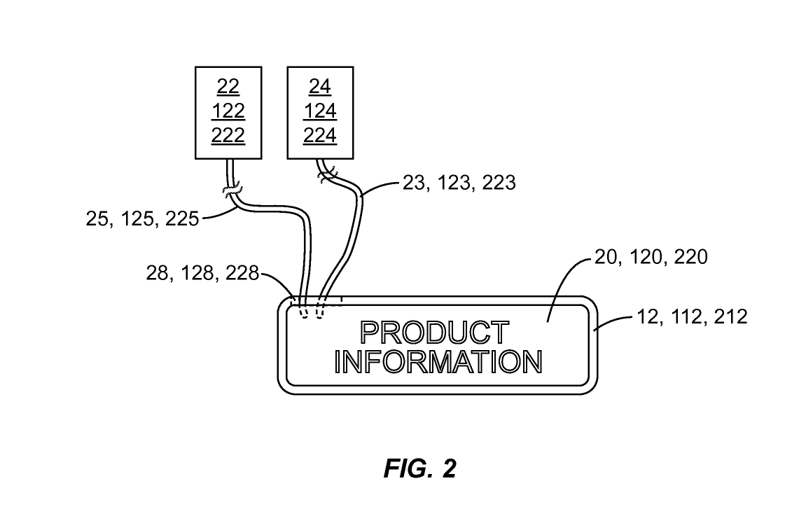

FIG. 2 shows a media display device 20 capable of being connected to a power source 22 to provide needed power to display the product information. The power source 22 may be a battery, connection to a conventional AC wall outlet, solar power, or other low voltage power source. The media display device is also capable of being in electronic connection and communication with a programmable product information control source 24, which provides the product information for display on the device 20 as will be further described below.

The mattress showroom display device 20 displays selectively changeable product information to a customer considering a mattress 30. As mattress products in the showroom change, or marketing programs change, product information may be developed and displayed via the media display device 20 on the corresponding mattress foot protector 10, headboard 110 and/or pillows 210, respectively. In other embodiments, more than one media display device may be associated with a foot protector 10, headboard 110 or pillows 210.

The media display device 20 is in electronic communication with a programmable product information source 24 to present a selectively changeable product information to the customer. The programmable product information source 24 can present differing information over the same display device 20. For example, the display device 20 can be programmed to show and/or describe one type of information, then moved to a different mattress and be reprogrammed to properly show and/or describe that mattress. The programmable product information source can also change the information periodically to present differing text or media about the same mattress to the customer as he/she is inspecting or approaching the mattress. Although not shown in the figures, the media display device can also play audio signals coordinated with displayed product information, via an audio source. The audio source may be played through speakers in the media display or a separate receiver in the showroom. In other embodiments, a sensor (not shown) in the display device or mattress activates the media display device when a person approaches the mattress 30 to attract his/her attention.

According to one aspect, the media display device 20 comprises an area of programmable light emitting units embedded in the flexible fabric panel 12. The media display is embedded in one or more fabric layers, a fabric-plastic film laminate, or other combination of textile and polymeric material that forms the flexible panel 12. “Programmable light emitting units” refers to light sources that can be programmed to display the product information. For example, the media display device may include light emitting diodes, organic light emitting diodes, polymer light emitting diodes, inorganic light emitting diodes, electroluminescent materials, electroluminescent pixels or electroluminescent pixel arrays, or any light source capable of being programmed to present video and/or moving images. One example of technology that makes this possible is the Phillips Lumalive displays available from Koninklijke Phillips Electronics N.V. This technology is further described in U.S. Pat. No. 7,682,034, which is hereby incorporated by reference. In another example, the technology is flexible media displays available from NanoLumens, LLC, which is further described in U.S. Patent Application Publication No. 2009/0219225, which is also hereby incorporated by reference. In an alternate embodiment, the media display includes thin plasma and/or a thin LCD screens embedded in the flexible panel 12. Further, one or more additional light diffusing layers may be included with the light emitting units as needed.

The media display device 20 can present product information it receives from the corresponding product information source 24. As shown in FIG. 2, the product information may be received via cable and/or wire 23 from product information source 24. The product information source 24 may be a series of instructions stored in a computer memory in the display device 20, or stored in a removable computer memory. Further, product information can be received wirelessly over a communications network from the product information source 24. In such an embodiment, the foot protector 10, headboard 110, pillow 220, or flexible panel 12 may include a transmitter/antenna for receiving the wireless signal. The instructions may then be transmitted to the media display device 20 to cause the display of the product information thereon. In other embodiments, the media display 20 may play product information in formats including, but not limited to, MPEG, JPEG, MJPEG, DVIZ, XVIS, AVI or DVD and HDDVD formats. The media display may display HD formats in 480p, 480i, 720p, 1080p, 1080i or 1086, or other formats.

The flexible panel 12 may include a wire housing 28 that begins proximate the media display device and extends toward the perimeter of the flexible panel. The wire housing 28 routes and protects various wires emanating from the media display device 20 e.g., power cords, ethernet cables, coaxial cable, A/V cables, S-video cables, HDMI wires, etc. The wire housing may be a hook and loop fastener casing, a fabric panel attached to the undersurface of the flexible panel or any other mechanism for managing and protecting wires on the panel.

In a preferred embodiment, the flexible panel 12 is a textile material including, but not limited to, a woven, knit, or non-woven material. In other embodiments, the flexible panel is a polymeric material including, but not limited to, polyvinyl chloride (PVC), polyethylene terepthalate (PET), polyethylene (PE) or polypropylene (PP). In still other embodiments, the flexible panel is a laminate of one or more layers of any combination of a textile or polymeric material.

The media display device 20 may be used with any type of mattress and mattress and/or bedding component. For example, twin, twin XL, full, queen, king, the “California king,” are exemplary sized mattresses, and associated headboards. In addition, the media display device 20 may be used on any mattress including, but not limited to, innerspring, foam (viscoelastic and/or latex), air, futons, and waterbeds.

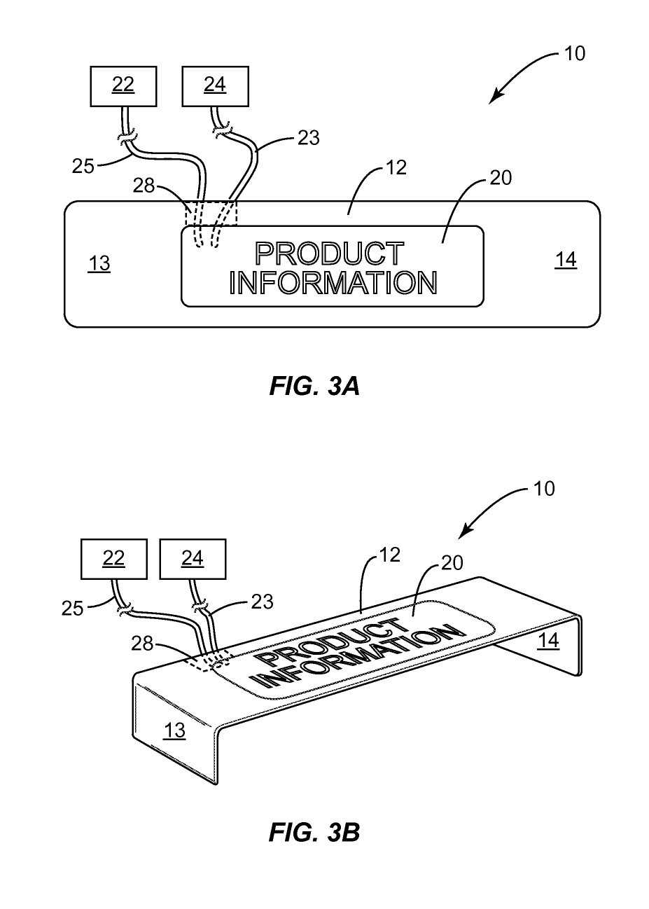

Turning now to FIGS. 1A and 3, a mattress foot protector 10 is releaseably attached to the mattress 30, such as a display mattress in a retail showroom. The mattress foot protector 10 includes a flexible panel 12 having opposed ends 13 and 14, and a media display device 20 embedded or otherwise incorporated into or onto the panel 12. In the embodiment as shown in FIG. 1B, the media display device 20′ is incorporated onto a foot protector 10′ positioned on the upper surface of the mattress 30. In yet another embodiment, the media display device 20 may be incorporated onto the mattress itself.

In the embodiment shown in FIG. 1A and 1B, a power source 22 connected to the media display 20 provides needed power to display the product information, and may be a battery, connection to a conventional AC wall outlet, solar power, or other low voltage power source as described above. The programmable product information control source 24 in electronic communication with media display device 20 provides the product information for display to a customer considering a mattress.

Further, the foot protector 10 shown FIG. 1A and 10′ shown in 1B minimizes damage, soiling or wear to the mattress when a prospective purchaser is testing the mattress in the showroom. The mattress foot protector 10 (and 10′ in FIG. 1B) is formed of any flexible panel 12 as described above. The foot protector may also have a decorative hem or other stitching along its perimeter to minimize fraying and to also provide a design effect. The foot protector may also include an embroidered image, design, logo or other design effect, in addition to content displayed via the media in display 20.

As shown in FIGS. 1A, 3A and 3B, the foot protector 10 is shown having a length at least as wide as the mattress 30 so that ends 13 and 14 of the foot protector 10 may be tucked under the mattress foot portion 36 of the mattress 30 to secure the protector 10 thereto. In other embodiments, the foot protector 10 includes a mechanical fastener and/or cordage to secure the foot protector 10 to the mattress 30. In still other embodiments, the ends of the foot protector may include tassels and the like. While a foot protector is shown covering the side portions 34 of mattress 30, the foot protector 10 may be designed to rest on the upper surface 32 of the mattress 30 with or without adhesive. In other embodiments, the foot protector 110 may include more than one media display device.

FIG. 1B shows a media display device 20′ releaseably attached to the foot protector 10′ placed on the foot portion 36 of a mattress 30 in a retail showroom. As with the embodiment shown in FIG. 1A, the media display device 20′ is embedded or otherwise incorporated into or onto the flexible panel 12′. A power source 22 connected to the media display 20′ provides needed power to display the product information, while the programmable product information control source 24 provides the product information for display to person proximate the mattress. Power source 22 product information control source not shown in FIG. 1B.

The display device 20′ shown in FIG. 1B may include a mechanical fastener (not shown) and/or cordage to secure the device 20′ and panel 12′ to the protector 10′. In other embodiments, the media display device 20′ may be designed to removably attach to the surface of the mattress with or without adhesive.

Turing now to FIG. 1C, a media display device 20 is shown associated with a headboard 110 of a display mattress 30 in a retail showroom. The media display device 20 includes a flexible panel 12 having opposed ends 113 and 114, and a media display embedded or otherwise incorporated into or onto the panel 12. The media display device 20 is formed of any flexible panel 12 as described above. The media display device 20 also has a power source 22 connected to the media display device 20. A programmable product information control source 24 provides the content for display on display device 20 as described above.

As shown in FIG. 1C, the media display device 20 is shown having a shape that has a smaller surface area than the exposed surface area 111 on headboard 110. The media display device 20 includes a mechanical fastener (not shown) and/or cordage for removable attachments to the headboard 110. In still other embodiments, the media display device 20 may be designed to removably attach to the surface 111 of the headboard 110 with or without adhesive. In other embodiments, the headboard 110 may include more than one media display device.

FIG. 1D shows a media display device 20 associated with a one or more pillows 10 on a mattress 30 in a retail showroom. While a rectangular pillow is shown, any pillow size and shape may be used. The media display device 20 includes a flexible panel 12 having a perimeter 225, and a media display embedded or otherwise incorporated into or onto the panel 12. As with other embodiments described above and shown in FIG. 1A and 1C, the media display device 20 has a power source 22 and a programmable product information control source 24. In addition, the media display device 20 is formed of any flexible panel 12 as described above.

As shown in FIG. 1D, the media display device 20 is shown having an outer perimeter 225 within the pillow perimeter 215. In alternate embodiments, the display device perimeter 225 may about the same size and shape as the pillow perimeter 215. The media display device 20 includes a mechanical fastener (not shown) and/or cordage for removable securement the pillows 210. In still other embodiments, the media display device 210 may be designed to removably attach to the surface 211 of the pillow with or without adhesive. The pillow 110 may include more than one media display device.

Although the present invention has been described with exemplary embodiments, it is to be understood that modifications and variations may be utilized without departing from the spirit and scope of the invention, as those skilled in the art will readily understand. Such modifications and variations are considered to be within the purview and scope of the appended claims and their equivalents.

1. A mattress showroom display device for a mattress foot protector, mattress, headboard or pillow on display in a mattress showroom, the mattress showroom display device presenting selectively changeable product information regarding the mattress, the display device comprising:
a panel of such size and shape as to cover at least a portion of a surface of the mattress foot protector, mattress, headboard, or pillow;
a media display in the form of an area of programmable light emitting units associated with the flexible panel for presenting the selectively changeable visual product information regarding the mattress; and
the media display having the capability to connect to a power source and a programmable product information control source.

2. The mattress showroom display device of claim 1, wherein the panel is formed of one or more layers of fabric.

3. The mattress showroom display device of claim 2, wherein the media display is embedded in the one or more layers of fabric.

4. The mattress showroom display device of claim 1, wherein the media display comprises light emitting diodes.

5. The mattress showroom display device of claim 1, wherein the media display comprises electroluminescent pixels or electroluminescent pixel arrays.

6. The mattress showroom display device of claim 1, wherein the media display comprises organic light emitting diodes.

7. The mattress showroom display device of claim 4, wherein the light emitting diodes are associated with a laminated flexible plastic panel.

8. The mattress showroom display device of claim 1, wherein the media display is in wireless electronic communication with the programmable product information control source.

9. The mattress showroom display device of claim 1, wherein the display is associated with a foot protector.

10. The mattress showroom display device of claim 9, wherein the foot protector has two opposed ends, the foot protector having a length that is greater than the width of the mattress so that when the foot protector is placed on the upper surface of the mattress, the two ends extend down the side of the mattress.

11. The mattress showroom display device of claim 9, wherein the panel is placed on and used in association with the mattress foot protector.

12. The mattress showroom display device of claim 1, further comprising a sensor that activates the media display when a person approaches the display.

13. The mattress showroom display device of claim 1, further comprising an audio signal associated with and coordinated with the selectively changeable visual product information.

14. The mattress showroom display device of claim 1, wherein the display device is associated with the headboard.

15. The mattress showroom display device of claim 14, wherein the panel has two opposed ends, the panel having a length that is less than the width of the headboard.

16. The mattress showroom display device of claim 1, wherein the display device is associated with the pillow.

17. The mattress showroom display device of claim 16, wherein the flexible panel forms the pillow.

18. The mattress showroom display of claim 1 wherein the panel with the media display are the foot protector.
